(19) United States
(12) Patent Application Publication
(10) Pub. No.: US 2005/0089633 A1
(43) Pub. Date: Apr. 28, 2005

(54) Method for decorating objects

(75) Inventor: Giancarlo Fenzi, Illasi (IT)

Correspondence Address: NIXON & VANDERHYE, PC, 1100 N GLEBE ROAD, 8TH FLOOR, ARLINGTON, VA, 22201-4714, US

(73) Assignee: V.I.V. International S.p.A., Cazzano di Tramigna (IT)

(21) Appl. No.: 10/963,762

(22) Filed: Oct. 14, 2004

(30) Foreign Application Priority Data
Oct. 23, 2003 (IT) IT-MO2003A000288

(51) Int. Cl. B05D 5/00

(52) U.S. Cl. 427/248.1; 427/430.1

(57) ABSTRACT

A method for decorating an object comprises positioning on the surface of a solvent a transfer film provided with a soluble layer associated with a decorative layer of sublimable inks, and immersing said object in said solvent so that said decorative layer remains associated with said object, said decorative layer being in direct contact with said soluble layer in said transfer film.

The invention relates to a method for decorating objects, particularly for decorating objects by transferring a transferable-ink image initially printed on a support layer.

This method may for example be used for decorating metal objects, in particular profiled elements, or objects in glass, in wood, in plastics or textiles. The method enables decorative patterns to be applied, in particular in imitation of wood or marble, but also of other ornamental effects.

FR 2730449 discloses a transfer film comprising a support layer in polyvinyl alcohol, on which a finishing layer, a decorative layer, a base layer and a fixing layer are applied in sequence. The transfer film disclosed above is positioned on the surface of a liquid in contact with which the support layer dissolves, leaving the remaining four layers on the free surface of the liquid. When the object to be decorated is immersed in the liquid the four layers stick to the surface of the object, forming a decorative pattern on it. In particular, the fixing layer is arranged in direct contact with the surface of the object to improve the adhesion of the decorative pattern to the surface; the base layer provides a uniform background colour and the finishing layer enables the decorative pattern to be protected from chemical, atmospheric and mechanical agents and the like that could damage it. The decorative layer comprises the decorative pattern and can for example be made by means of sublimable colours.

After the above disclosed four layers have stuck to the object to be decorated, the latter is placed in a kiln, where it is heated to a temperature that is sufficient to ensure the sublimation of the colours that form the decorative layer and their diffusion in the layers below. According to the disclosure in FR 2730449, the finishing layer arranged externally the decorative layer acts as an elastic membrane and exerts a pressure on the decorative layer that facilitates the sublimation process.

A drawback of the decorating process disclosed in FR 2730449 is that the finishing layer tends to get damaged when it is subjected to the relatively high temperatures that are required to obtain sublimation of the colours of the decorative layer.

The transparent paint that make up the finishing layer have in fact already undergone a process of at least partial reticulation during their application to the transfer film and are unable to resist temperatures above 150° C., such as those temperatures that are normally reached during the sublimation phase. For this reason, fissures may form in the finishing layer, during the time in the kiln, which impair the quality of the decoration obtained.

Furthermore, the transfer film disclosed in FR 2730449 has a complicated structure that makes it particularly expensive.

An object of the invention is to improve the procedures for decorating objects by transferring an image initially printed on a support layer.

A further object of the invention is to provide a method for decorating objects that enables high-quality decorations to be obtained that are substantially free of surface fissures.

A further object of the invention is to simplify the structure of the transfer films that are used in the methods of decoration of objects by transferring an image of transferable colours.

According to the invention, a method is provided for decorating an object comprising positioning on the surface of a solvent a transfer film provided with a soluble layer associated with a decorative layer of sublimable inks, and immersing said object in said solvent so that said decorative layer remains associated with said object, characterised in that said decorative layer is in direct contact with said soluble layer in said transfer film.

Owing to the invention, it is possible to obtain an object provided with a decorative layer to be consolidated by means of heat treatment, the object being devoid of further layers arranged externally the decorative layer. There are thus no external layers, in which fissures or other faults could form during the heating phase that is necessary to obtain the sublimation of the colours of the decorative layer. This enables high-quality decorations to be obtained.

Furthermore, the structure of the transfer film is significantly simplified.

The invention will now be disclosed with reference to the attached figures, which illustrate an embodiment by way of non-limiting example, in which:

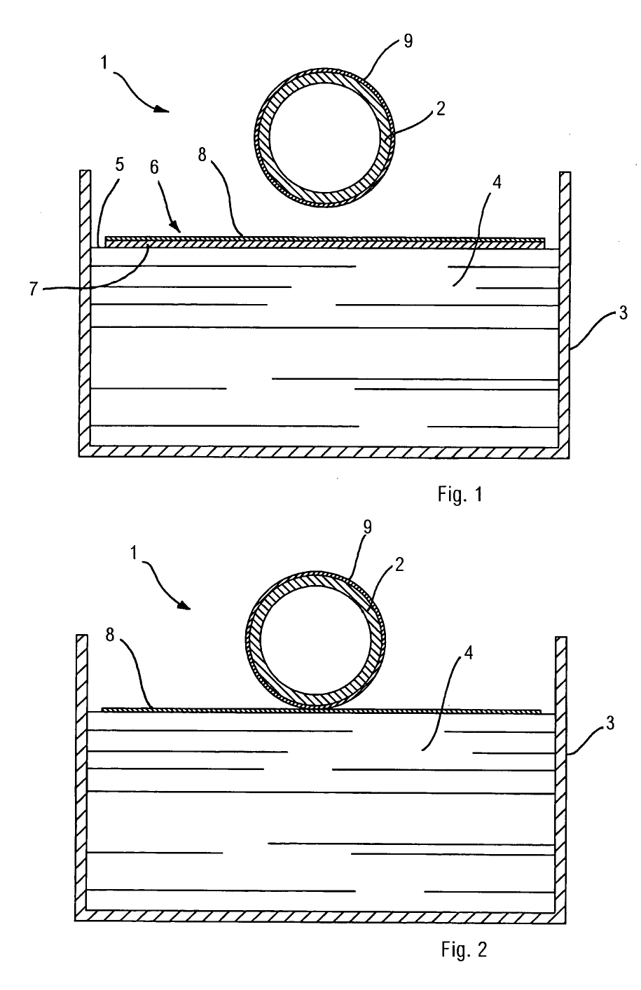

FIG. 1 is a schematic section showing a first operating phase of a method for decorating objects;

FIG. 2 is a section like the one in FIG. 1, showing a second operating phase of this method;

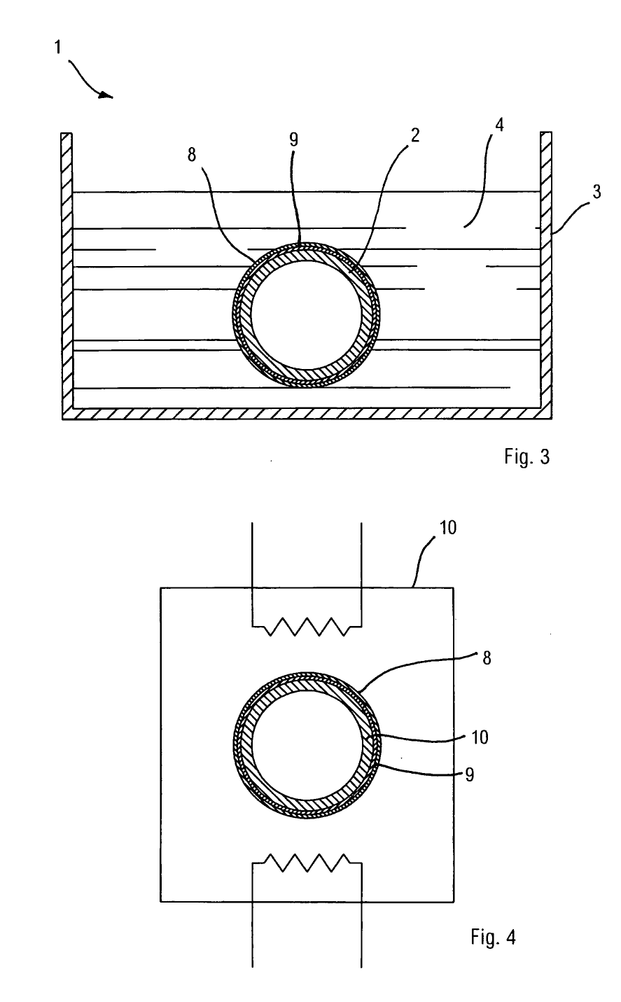

FIG. 3 is a section like the one in FIGS. 1 and 2, showing a third operating phase of the above said method;

FIG. 4 is a section like the one in the preceding Figures, showing a final phase of the method in FIG. 1.

In FIG. 1 an apparatus 1 is shown for decorating an object 2, in particular a glass bottle, shown in section in FIG. 1.

The apparatus 1 comprises a tank 3 containing a solvent 4, for example water, on the free surface 5 of which a transfer film 6 is initially positioned.

The transfer film 6 comprises a soluble layer 7 made from a material such as polyvinyl alcohol that is able to dissolve in the solvent 5, with which a decorative layer 8 of sublimable inks was first associated, the sublimable inks being arranged according to a desired pattern. In the transfer film 6, the soluble layer 7 is arranged in direct contact with the decorative layer 8.

On the external surface of the object 2 to be decorated, may have been previously applied a base layer 9 suitable for providing a background colour for the decoration or for improving adhesion of the decoration to the object 2. The base layer 9 may be applied in liquid or powder form by means of known devices, comprising for example a gun device. This layer is usually not used when objects in plastic matter have to be decorated, since their surfaces are already able to receive sublimable inks and do not require auxiliary layers.

In one version that is not shown, externally the base layer 9 a transparent layer is further applied having the function of increasing definition of the decoration. In fact, the transparent layer prevents sublimable colours from mixing with the colours of the base layer 9, which could cause blurring of the pattern. The transparent layer, too, can be applied in liquid or powder form.

As shown in FIG. 1, the soluble layer 7 is positioned in direct contact with the free surface 5 of the solvent 4, which dissolves the soluble layer 7. On the free surface 5 of the solvent 4 the decorative layer 8 therefore remains.

The object 2 to be decorated is then brought up to the tank 3, as shown in FIG. 2, and subsequently immersed in the solvent 4, as shown in FIG. 3.

When the object 2 to be decorated is immersed in the solvent 4, the decorative layer 8, that was previously floating on the free surface 5, adheres to the external surface of the object 2, as shown in FIG. 3. In this way, the decorative layer 8 is transferred to the object 2 to be decorated.

The object 2 is then extracted from the tank 3 and placed in a kiln 10, as shown in FIG. 4. In the kiln 10, the object 2 remains for a time comprised between a few tenths of a second and a few minutes and is heated to a temperature comprised between approximately 150° C. and 220° C. At these temperatures, the inks that form the decorative layer 8 are sublimated, penetrating inside the base layer 9. In the case of objects in plastic material, to which the base layer 9 has not been applied, the sublimable inks penetrate directly on the surface of the object.

A decoration that is firmly fixed to the object 2 and that is provided with significant resistance to abrasion is thereby obtained. Furthermore, as externally to the decorative layer 8 additional layers provided with poor heat resistance are not arranged, the risk of damage to visible layers during the heating phase is eliminated.

1. Method for decorating an object, comprising positioning on the surface of a solvent a transfer film provided with a soluble layer associated with a decorative layer of sublimable inks, and immersing said object in said solvent so that said decorative layer remains associated with said object, wherein said decorative layer is in direct contact with said soluble layer in said transfer film.

2. Method according to claim 1, wherein after said immersing, there is provided heating said object associated with said decorative layer in order to obtain the sublimation of said sublimable inks.

3. Method according to claim 2, wherein said heating comprises subjecting said object to temperatures comprised between about 150° C. and 220° C.

4. Method according to claim 1, wherein said soluble layer comprises a layer of polyvinyl alcohol.

5. Method according to claim 1, and further comprising, before said immersing, applying to said object a base layer, suitable for enabling said decorative layer to adhere more easily to said object.

6. Method according to claim 5, wherein said base layer is applied in liquid or powder form.

7. Method according to claim 1, and further comprising further applying a transparent layer to said object.

8. Method according to claim 5, and further comprising further applying a transparent layer to said object.

9. Method according to claim 7, wherein said transparent layer is applied in liquid or powder form.

10. Method according to claim 8, wherein said transparent layer is applied on said base layer.

11. Method according to claim 1, wherein said solvent comprises water.
